(19) United States
(12) Patent Application Publication
(10) Pub. No.: US 2014/0011465 A1
(43) Pub. Date: Jan. 9, 2014

(54) MOLDED CONDUCTIVE PLASTIC ANTENNA

(71) Applicants: Chris R. SNIDER, Noblesville, IN (US); Phillip W. KELLY, Kokomo, IN (US)

(72) Inventors: Chris R. SNIDER, Noblesville, IN (US); Phillip W. KELLY, Kokomo, IN (US)

(73) Assignee: DELPHI TECHNOLOGIES, INC., Troy, MI (US)

(21) Appl. No.: 13/542,069

(22) Filed: Jul. 5, 2012

(51) Int. Cl. H04B 1/38

(52) U.S. Cl. 455/90.2

(57) ABSTRACT

A housing for a vehicle audio system includes a trim panel assembly and a box-like case forming a partially closed cavity. The trim panel assembly includes a decorative molded plastic face plate carrying vehicle occupant accessible controls and displays, and a printed circuit board disposed in a spaced relationship behind said face plate. An audio device and a radio frequency communication device are mounted within the housing. The communication device has a generally “L” or “T” shaped antenna formed of electrically conductive plastic material having a thermal expansion characteristic substantially equal to that of said decorative face plate. The antenna includes an elongated element insert molded within the face plate and a feed portion which extends rearwardly from said element to mechanically and electrically engage the printed circuit board. The feed portion self-engages a PCB via for retention in a fixed, spaced relationship with the decorative face plate.

### TECHNICAL FIELD

The present invention relates to insert-molded components configured for mounting within the passenger cabin of a motor vehicle and, more particularly, to an electrical component which is insert-molded within an audio system trim panel for automotive applications.

### BACKGROUND OF THE INVENTION

Wireless communications is made possible by wireless electronic devices such as cellular telephones, pagers, FOBs, smart cards, personal digital assistants and entertainment devices, and two-way radios (e.g. family radio service or citizens band personal radio service (FRS) radios and general mobile radio service (GMRS) radios), to name a few. Each of these devices must include an antenna to transmit and receive information-bearing electromagnetic signals. The physics of radio frequency (RF) design require that the antenna present a proper conductivity and impedance, as well as the proper wavelength and shape. Of course, these antenna characteristics are a function of the wireless of the wireless electronic device itself. Accordingly, antennas come in many shapes, sizes and forms depending upon the intended application.

Most antennas consist of a combination of electrically conductive and insulating materials. Antennas may be fabricating using conductive materials such as wires, tubes, stamped metal, and similar components. Subsequently, the metallic component may be encapsulated inside a plastic cover or case panel. The plastic component may be formed over the metal antenna by over-molding or simply by inserting the metallic element into a plastic sheath. Of course, the antenna must be connected to the radio circuitry using some means. This connection is typically implemented by a built-in connector. An arrangement of wires may be employed. Either way, the connective means is disposed between the antenna input/output and the RF circuitry. After the connector is coupled to the input side of the antenna, it may be connected to the RF circuitry by solder or some other connective means.

Automotive audio systems have incorporated consumer wants like Blue Tooth connectivity as an example to enable hands free phones and connectivity for various take along devices that may be present in the automobile. To accomplish this connectivity in the audio product antenna elements are needed to allow reception. The placement is critical within the vehicle passenger compartment to realize optimal functionality. Typically, there may be an element connected to the keyboard of the radio or directly placed on the top surface of the keyboard that faces the passenger compartment.

This application can be difficult regarding ensuring the element is connected during assembly of the radio and often there is not an ideal area of the radio front trim plate to locate the element. On the circuit board the antenna may be a chip that takes real estate away from other componentry and also may not be able to be located in an ideal region for the best performance.

FIGS. 1 and 1A illustrate the construction of a typical prior art automotive radio/compact disc (CD) player 10. Radio/CD player 10 comprises a radio subassembly whose principle circuit components are carried on a circuit board 12 and a CD player subassembly 14. The circuit board 12 and the CD player 14 are encased within a common chassis 16 made up of sheet metal components. Chassis 16 includes a wraparound housing 18 defining a back and sidewalls, a top cover 20, a bottom cover 22 and a front plate 24 which are interconnected by numerous threaded fasteners to collectively enclose the subassemblies. The top and bottom covers 20 and 22, respectively, are provided with large arrays holes or openings for airflow and ventilation of heat generated within the radio/CD player 10. A convector or heat sink 26 is carried on an outer surface of one of the chassis sidewalls and is interconnected through a port/window 28 to a power device assembly 30. A trim plate assembly 32, along with a support pad 34 and CD dust cover 36 are affixed to the front plate 24, providing an operator control interface with the radio/CD player 10. Circuit board 12 is electrically in-circuit with the CD player subassembly 14 through an intermediate flex wire cable 38 and with the power device assembly 30 through a jumper cable 40. Information bearing labels 42 and 44 are provided for future reference by the operator and service technicians. The radio/CD player 10 is electrically interconnected with an antenna, power supply, speakers and other related systems of a host vehicle by rear-facing connectors 46 carried on the circuit board 12 which are registered with openings 48 in the rear wall of wraparound housing 18. The radio/CD player 10 is mounted within a host vehicle by threaded fasteners passing through openings in mounting features 50 extending from front plate 24 and a rearwardly directed mounting bushing 52 which is threadably affixed to a stud carried on the outer surface of the rear wall 56 of wraparound housing 18.

The radio/CD player assembly 10 includes a near field communication (NFC) technology system including a discrete antenna assembly 56 mounted to extension tabs 58 integrally formed with the front plate 24 by suitable screws 60 and washers 62. The antenna assembly 56 includes an antenna chip 64 mounted on a dedicated PCB 66 and electrically interconnected with associated radio frequency (RF) electronics carried on PCB 12 via an antenna cable 68 dressed through an opening 70 in the front plate 24. One of the screws 60 are employed to establish a ground path to the front plate 24. Note the large number of threaded fasteners.

The radio/CD player 10 of FIGS. 1 and 1A is of ordinary complexity and may require fifty or more threaded fasteners to complete the manufacturing process. Installation of that many fasteners may require that the in-process chassis be re-positioned/re-fixtured ten to fifteen times as it passes along an assembly line of eight to ten skilled workers/work stations.

Vehicle entertainment systems usually include an audio component such as a radio to enable receiving signals from antennas, contain various forms of playback mechanisms, and have the capacity to accept data from user devices like MP3 players. Typically, the radio has a decorative assembly that provides man-machine interface as well as displaying pertinent data relative to the selected media and audio settings. Also, the back-end or chassis is constructed of metal to provide various functions to ensure the performance of the radio in the vehicular environment. The structure to contain the mass from playbacks, the heat conductive properties, and the electrical shielding and grounding are just a few of the advantages to using the metal construction. Unfortunately, with the density of the metal, the disadvantage of added weight is a side effect of the typical construction. In a vehicle, added weight impacts fuel economy, as well as other hidden costs during assembly that can effect the cost of the product, like sharp edges of metal can be a potential hazard for assemblers in the manufacturing plant as well as added weight can limit the packaging of multiple parts in containers for inner and outer plant distribution.

### SUMMARY OF THE INVENTION

Typically a molded plastic faceplate on the front of a vehicular radio has ideal cabin exposure for incorporating an antenna element. The proximity to the keyboard of the radio can facilitate an electrical connection favorable for the functional linkage of the antenna with the device requiring the antenna. There exists specialty plastics that have electrical conductivity achieved by special engineered resins that are moldable and can be processed via a two-shot process into the required physical parameters to provide the best reception for the required device. The first shot would provide the antenna element and the required geometry to provide a suitable interface with the keyboard for the necessary electrical interface. This would enable an efficient method of providing an antenna element that does not use unnecessary circuit board real estate and be in a relatively ideal location for cabin connection from a take along device like a cellular phone as an example due to the element being unobstructed and centrally located. The conductive portion of the faceplate is the antenna element being the first shot and the second shot would be the normal face or trim plate material like a polycarbonate (non-conductive) as an example that can cover the antenna shot for first surface acceptability and provide the overall faceplate/trim plate features and structure. The antenna element can be connected to the keyboard circuit board either inserting it by plating a slot or hole and having the detail design of the antenna element provide a contact interface to the plated slot or hole. Also a cylindrical hole could be provided in the antenna shot to receive a screw through a hole with ground pad that will be secured with the screw passing through the circuit board and into the conductive plastic material shot to electrically connect the antenna to the circuit board. Although an automotive application is described here, the present invention could also be used for other devices with a plastic enclosure that may have the antenna for a variety of applications including a global positioning system (GPS) as another example and requiring circuit board connection from the antenna element. The antenna could be molded in the conductive plastic resin and attached to either the circuit board or the trim plate first before the radio assembly is accomplished as an alternative method to this invention.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is an exploded, perspective view of a prior art automotive radio/CD player combination in a common chassis constructed of sheet metal and a large number of threaded fasteners;

FIG. 1A, is an exploded perspective view of the front plate of FIG. 1, on an enlarged view, illustrating the detail of a prior art discrete near field communication antenna assembly;

FIG. 2, is a perspective view of the cockpit area of an automobile, illustrating an instrument panel mounted audio system embodying the present invention;

FIG. 3, is a front plan view of the trim bezel assembly of the audio system of FIG. 2, on an enlarged scale;

FIG. 4, is a right-rear perspective view of the trim bezel assembly of FIG. 3, on a further enlarged scale;

FIG. 5, is broken, cross-sectional view of the trim bezel assembly taken on lines 5-5 of FIG. 4, illustrating the details of an integrated near field communication assembly and its interconnection with an associated RF circuit located within an associated audio system case;

FIG. 5A, is a broken, partial plan view of the feed portion of the insert molded antenna of FIG. 5, on an enlarged scale; and

FIG. 6, is a broken, cross-sectional view of the trim bezel assembly of FIG. 4, taken on lines 6-6 of FIG. 5.

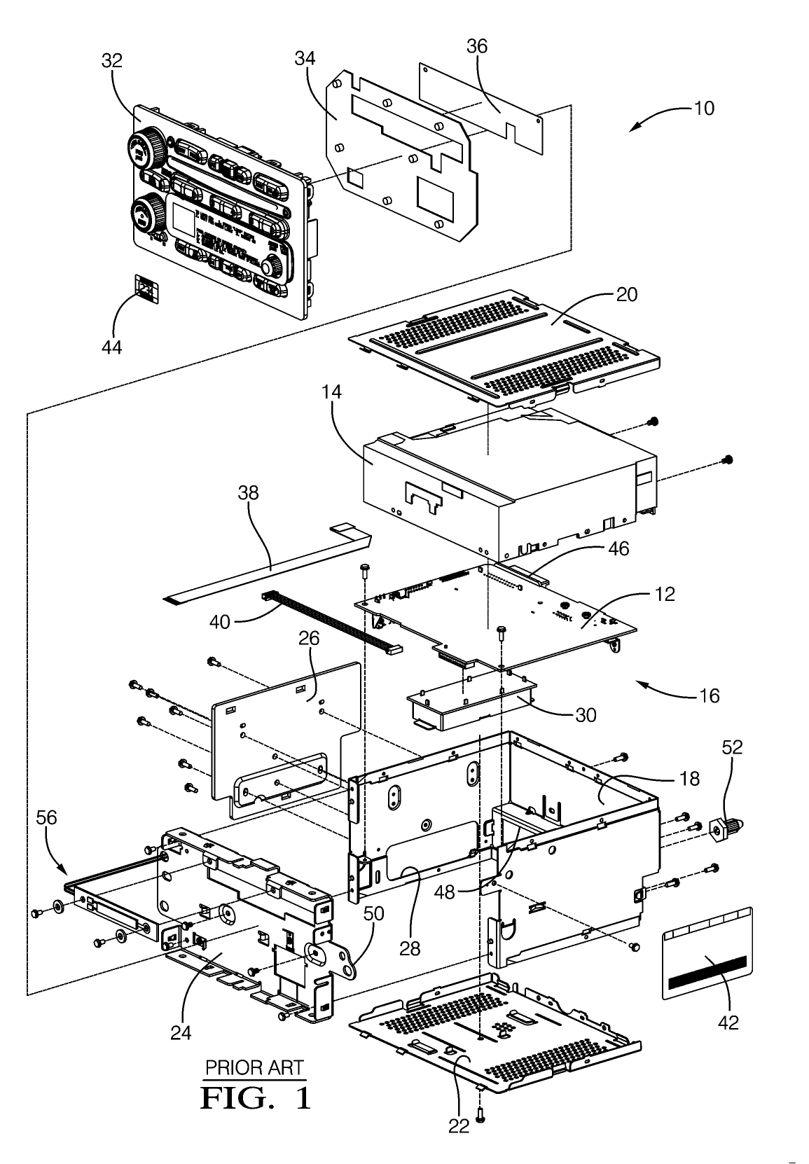

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

The present invention represents an improvement of the device described and illustrated in U.S. Pat. No. 7,733,659 B2 entitled “LIGHTWEIGHT AUDIO SYSTEM FOR AUTOMOTIVE APPLICATIONS AND METHOD” to Chris R. Snider et al. and assigned to the common assignee of the present invention. The entire specification and drawings of U.S. Pat. No. 7,733,659 B2 are incorporated herein by reference.

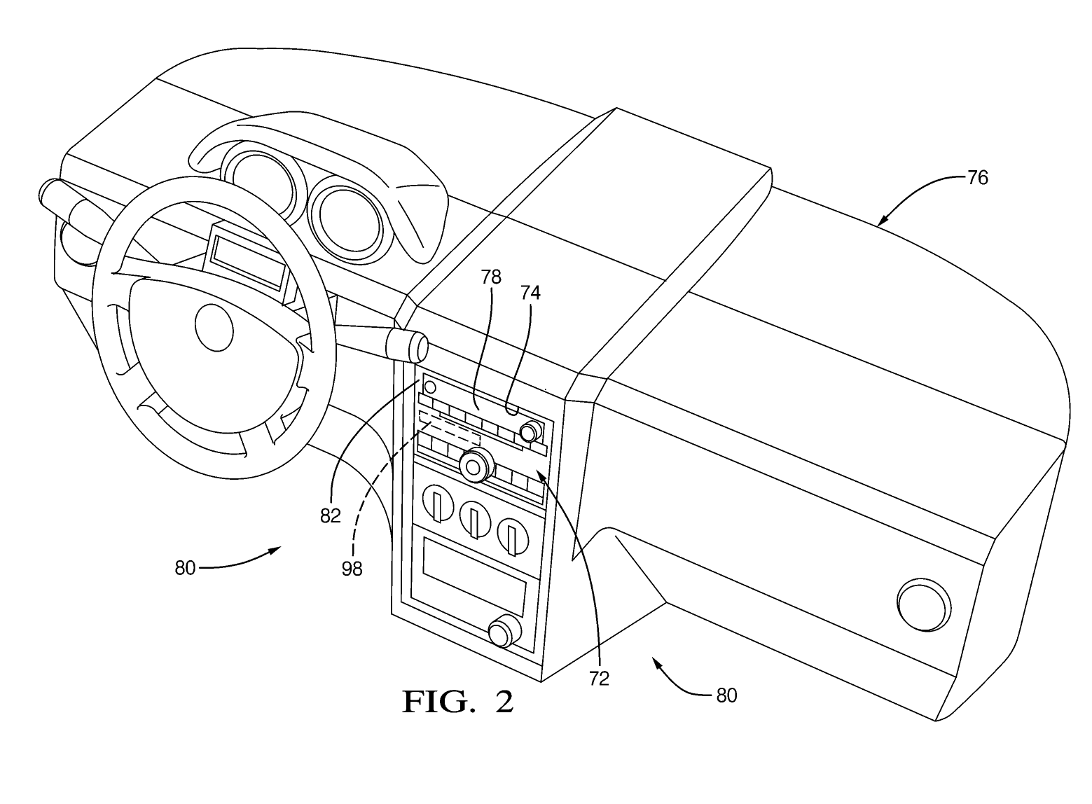

Referring to FIG. 2, an electronic system housing assembly 72, embodied in one application as an automotive audio system, is illustrated in assembly within a central opening 74 formed in an instrument panel 76 of a host automobile. The housing assembly 72 includes a three-dimensional case cooperating with an operator accessible trim panel assembly 78. As will be described in greater detail herein, the case and trim panel 78 and/or a discrete closure member cooperate to define a substantially closed cavity for carrying at least one electronic component such as a radio frequency circuit assembly.

In the illustrative embodiment of the invention, the instrument panel opening 74 is located conveniently adjacent a designated operator seating position whereby input/output devices and displays of the audio system assembly 72 installed therein are easily accessible. Furthermore, the audio system assembly 72 is positioned near the centerline of the host vehicle and facing into the passenger cabin 80. So positioned, the audio system assembly 72 is effectively in a direct line-of-sight of the driver seating area, the front passenger seating area and the rear/mid-seat (left, center and right) seating areas of the host vehicle. The instrument panel opening 74 is configured to nestingly receive the audio assembly 72 which is front-loaded therein.

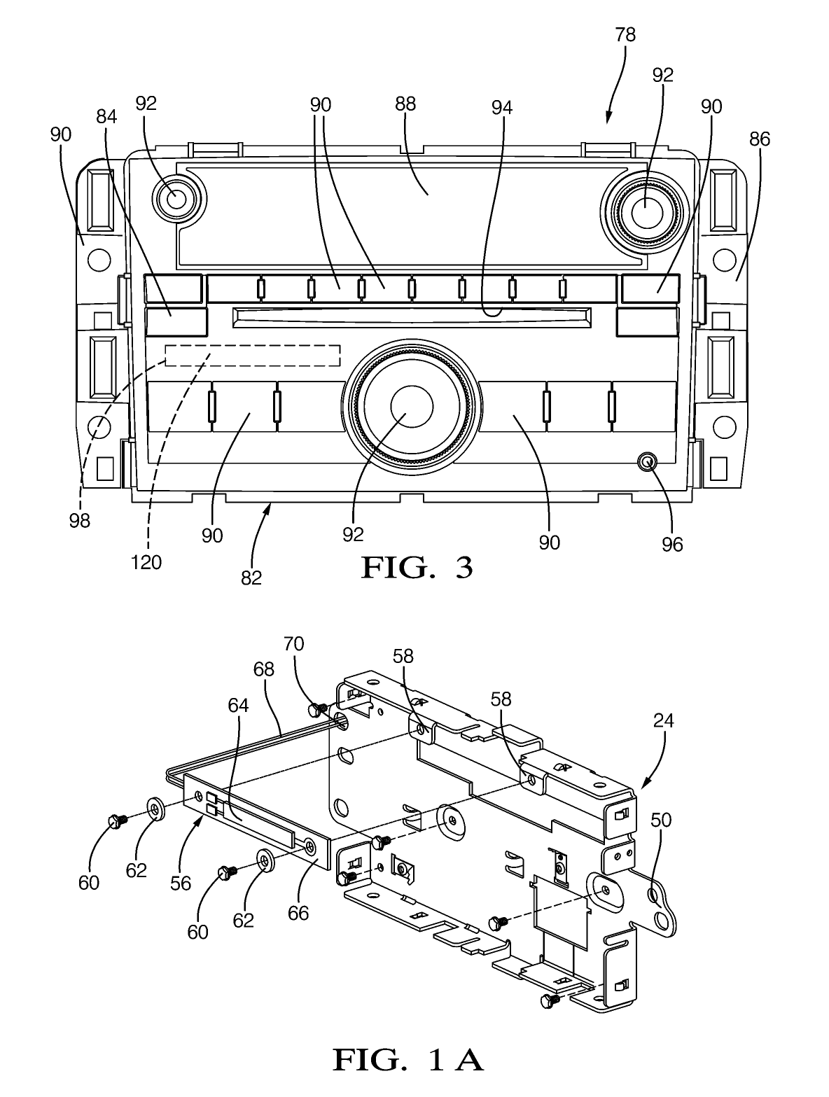

Referring to FIG. 3, the trim panel assembly 78 includes an ornamental escutcheon 82 formed of injection molded electrically insulating plastic material including laterally opposed left and right mounting flanges, 84 and 86, respectively, and framing a display 88, operator controls, such as push buttons 90 and rotary knobs 92, a media access opening 94, and a port 96 for interfacing with portable digital devices. Additionally, the audio system associated with the trim panel assembly 78 includes a radio frequency communication device providing an RF link with portable digital devices, such as personal computers, cellular phones, Wi-Fi™ and BlueTooth™ devices, possessed by occupants within the vehicle passenger cabin 80. For purposes of this application, the audio system 10 described herein will include a radio frequency communication device configured for compatibility with a BlueTooth™ device.

The present invention can also be employed with a near field communication (NFC) device, which is a contactless, electromagnetic wireless technology designed to enable communications between two or more devices over very close distances, such as devices confined within the passenger cabin of a motor vehicle. NFC is based on a communication standard that specifies how two devices establish a peer to peer network in order to exchange data. NFC employs electromagnetic radio fields to communicate. This is in contrast to BlueTooth™ or Wi-Fi™ which use radio transmissions. However, as described herein, NFC is compatible with both technologies. It is inherently secure as the distance required is so close. NFC operates in two modes, “active” where both devices are generating their own RF fields, such as in the case where two mobile devices are being used to exchange data, and “passive” where one of the devices generates the RF field and the other device uses the field to power itself and communicate, such as where the active device is a “reader” and the passive device is a “tag”.

As will be described in greater detail herein-below, the radio frequency communication device embedded within the host vehicle audio system 72 will include an antenna 98 embedded within the ornamental escutcheon 82 so as to be effectively invisible to the vehicle operator/occupant.

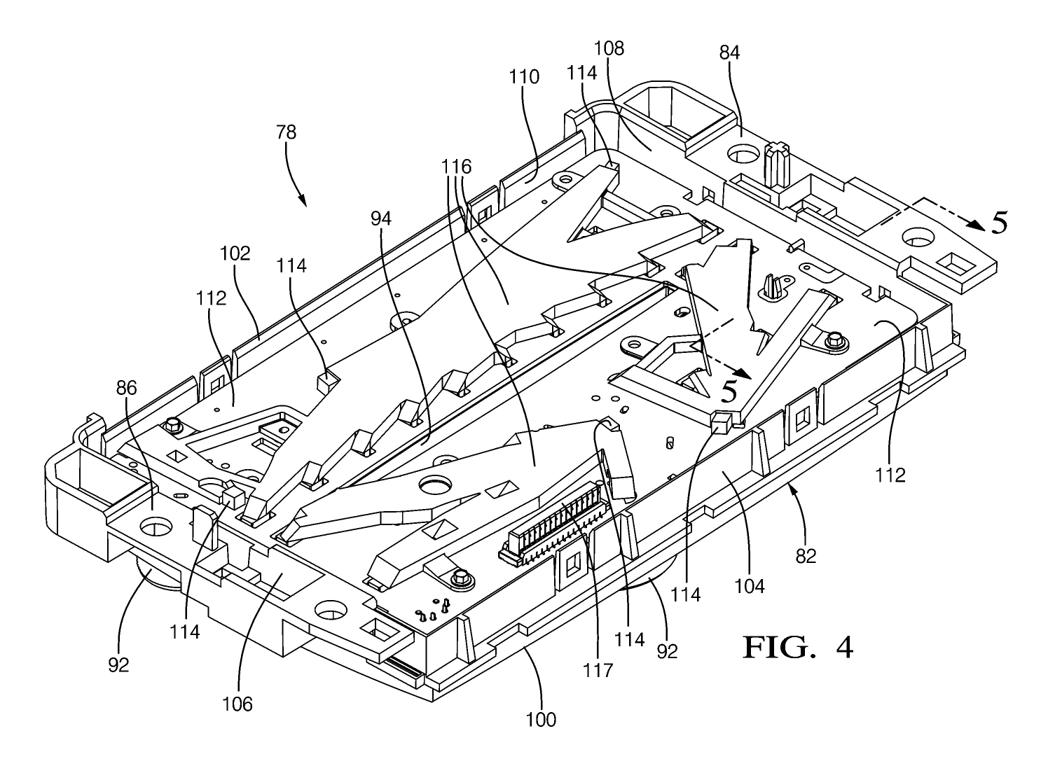

Referring to FIG. 4, the ornamental escutcheon 82 of the trim panel assembly 78 serves as a box-like enclosure, including a face plate 100 with a top wall 102, a bottom wall 104, a right side wall 106 and a left side wall 108 integrally formed with and extending longitudinally away from the face plate 100. The walls 102-106 have self-engaging, snap-action features incorporated therein to affect attachment of the trim panel assembly 78 to the case of an associated audio system disposed behind the trim panel assembly 78 as described in detail in U.S. Pat. No. 7,733,659 B2.

The ornamental escutcheon 82 defines a cavity 110 for positioning the display 88, push buttons 90, rotary knobs 92 and their associated electro-mechanical devices. A display-control PCB 112 is disposed within the cavity 110 overlaying the display and control elements and is spaced above the interior surface of the face plate 100 to effectively define a rear closure member of the trim panel assembly 78. The interior surface of the PCB 112 carries electronic components, conductive circuit traces and electro-mechanical operator input/output (I/O) devices. The outer surface of the PCB 112 carries light emitting diodes (LEDs) 114 and associated light pipes 116 operative to illuminate the trim panel 78. In addition, the outer surface of the PCB 112 carries additional circuit traces and an umbilical connector 117 for electrically interconnecting the circuitry carried by the trim panel assembly 78 with the circuitry and electro-mechanical devices carried within the associated audio system case.

A number of components carried by the PCB 112 and related application design details are not illustrated here for the sake of simplification and ease of understanding the present invention. A more through description is contained in in U.S. Pat. No. 7,733,659 B2 which has been incorporated herein by reference. Suffice it to say here that both sides of the PCB 112 tend, in application, to have an extremely high density of componentry and circuit elements carried thereon. This is problematic when placement of a radio frequency communication device antenna, such as antenna 98, in this area is required to ensure reliable RF interface with portable devices located in the host vehicle passenger cabin 80.

Referring to FIGS. 4-6, a detailed embodiment of the present invention is illustrated, as it relates to configuration and placement of the radio frequency antenna 98 within an automotive housing assembly 118. The radio frequency antenna 98 is generally “L” shaped, with an elongated first leg portion or element 120 insert molded within the face plate 100 of the ornamental escutcheon 82, and extending laterally parallel to the front face of the trim panel assembly 78, as illustrated in phantom in FIG. 3. The antenna 98 includes a second leg portion or feed 122 integrally formed at one end of the element 120 and extending rearwardly therefrom. The portion of the feed leg portion 122 nearest the “knee” of the antenna 98 is also insert molded within the face plate 100 of the ornamental escutcheon 82. The remainder of the feed leg portion 122 extends rearwardly in cantilever fashion from the rear surface of the face plate 100.

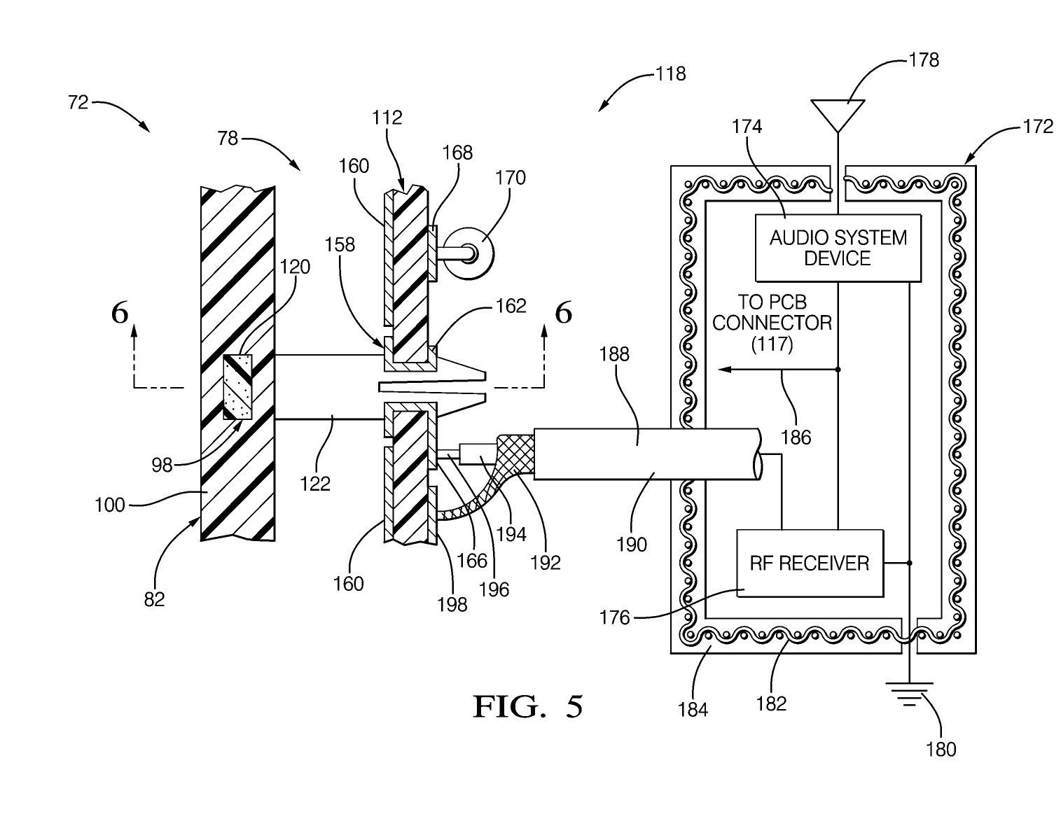

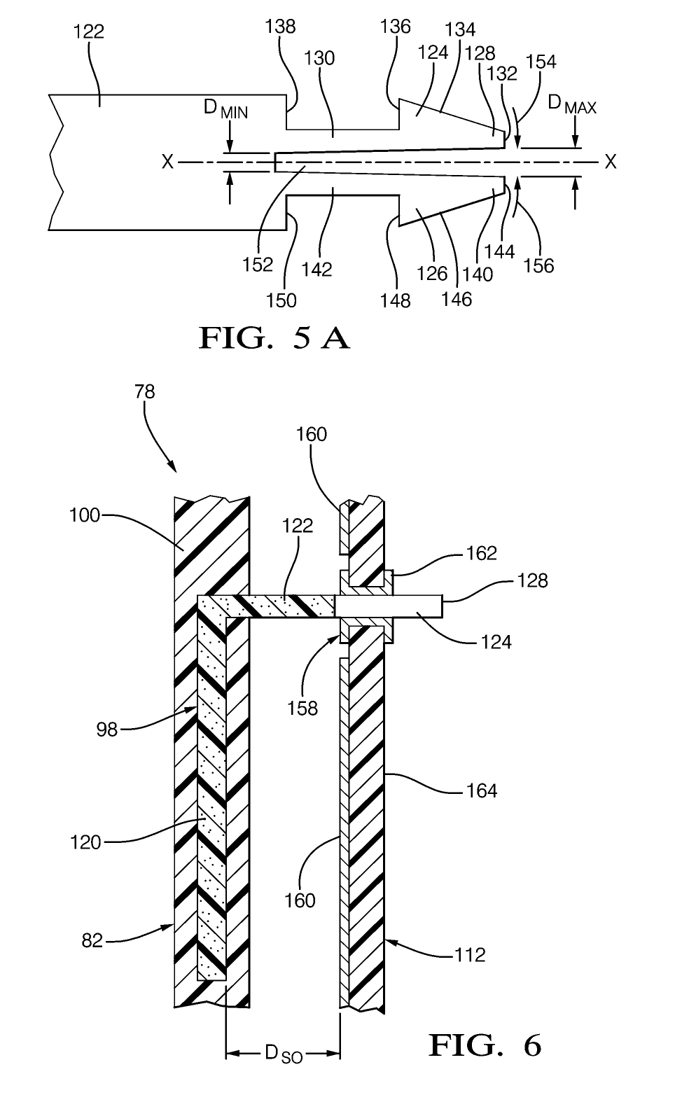

The ornamental escutcheon 82 is preferably injection molded as a single piece formed of electrically insulative thermoplastic material such as that sold by Sabic Innovative Plastics under the trade name “Cycoloy”. Similarly, the antenna 98 is preferably injection molded as a single piece formed of electrically conductive thermoplastic material such as that sold by Chomerics unit of Parker Hannifin under the trade name “Premier”. The Cycoloy and Premier materials have a synergistic relationship inasmuch as they have substantially similar characteristic coefficients of thermal expansion. Preferably, the ornamental escutcheon 82 and antenna 98 are simultaneously formed by a “dual shot” insert molding process wherein the antenna element 120 and a portion of the feed 122 is fully encapsulated within the ornamental escutcheon 82 located between the inner and outer surfaces of the face plate 100 as best illustrated in FIGS. 5 and 6. Alternately, the antenna 98 can be separately formed by injection molding or stereo lithography process and subsequently positioned within the cavity of a mold for the ornamental escutcheon 82. In either event, the antenna 98 is spaced behind the outer surface of the escutcheon 82, rendering it effectively invisible to the vehicle occupants. Although the antenna 98 is preferably formed exclusively of electrically conductive or semi-conductive material, it is contemplated that it can be made of a non-conductive shaped form having electrically conductive material embedded therein or plated on an outer surface thereof.

The antenna element 120 is illustrated as a beam that can be dimensioned within the overall size of the ornamental escutcheon 82 to correspond with the characteristic frequency of the RF system employed. The illustrated antenna 98 is dimensioned for optimized operation in the 2.4 gHz band. Alternatively, the antenna element 120 could be configured as a loop or other form.

Referring to FIGS. 5, 5A and 6, the feed 122 of the antenna 98 extends rearwardly from the rear surface of the face plate 100, terminating in a resilient bifurcated or forked structure consisting of cooperating upper and lower engagement tabs 124 and 126, respectively. The engagement tabs 124 and 126 are spaced-apart, forming a minor image of one another. The upper engagement tab 124 has a shaped head portion 128 interconnected to the remainder of the feed 122 by a thin-walled neck region 130. The head portion 128 forms a lead surface 132, a tapered longitudinal guide surface 134 and a laterally directed engagement surface 136. The point of transition of the neck region 130 with the remainder of the feed 122 forms a stop or laterally extending abutment surface 138. Similarly, the lower engagement tab 126 has a shaped head portion 140 interconnected to the remainder of the feed 122 by a thin-walled neck region 142. The head portion 140 forms a lead surface 144, a tapered longitudinal guide surface 146 and a laterally directed engagement surface 148. The point of transition of the neck region 142 with the remainder of the feed 122 forms a stop or laterally extending abutment surface 150. The upper and lower engagement tabs 124 and 126 are symmetrically aligned with an axis of elongation X-X of the antenna feed 122, and are laterally spaced by a gap 152. Thus configured, the upper and lower engagement tabs 124 and 126 are momentarily resiliently displacable during the assembly process from their substantially parallel orientation illustrated in FIG. 5 to an inwardly deflected orientation suggested by arrows 154 and 156. The gap 152 is tapered, transitioning from a minimum dimension “Dmin” at the inner (righthandmost) end thereof to a maximum dimension “Dmax” at the outer (lefthandmost) end thereof to maximize flexure during the assembly process and to minimize stress risers in the antenna 98. Although it could be varied, the taper is preferable configured at a constant pitch.

The display/control PCB 112 has a plated via 158 formed therein dimensioned to nestingly receive the antenna feed engagement tabs 122 and 124. The via 158 and engagement tabs 122 and 124 are preferably rectangularly shaped and dimensioned to effect a slip fit therebetween to affect a robust mechanical and electrical interconnection. Furthermore, the square shape of the antenna feed 122 and via 158 provides a “keyed” configuration, interlocking the antenna 98 to the PCB 112 to prevent relative rotation therebetween. The PCB 112 includes a conductive surface 160 forming a ground plane facing the antenna element 120. The conductive surface 160 is electrically isolated from conductive edge surfaces 162 of the via 158 which forms a portion of the antenna feed circuit. The surface 164 of the PCB 112 opposite the ornamental escutcheon 82 forms a mounting pad 166 in-circuit with the via edge surfaces 162, mounting pads 168 for electrical interconnection of various surface mount devices 170, and numerous circuit traces (not illustrated).

Referring to FIG. 5, the audio system assembly 72 includes the trim panel assembly 78 mounted to a shielded case 172 enclosing an audio system device 174 and an RF communication device 176. The shielded case 172 is preferably formed as a composite of an electrically conductive wire mesh screen 182 insert molded within relatively rigid polymer based material 184. The audio system device 174 typically includes a satellite and/or terrestrial antenna network 178, and a chassis ground 180, as well as electrical power, control inputs and audio signal outputs (not illustrated) interfacing with a host vehicle. The audio system device 174 and the RF communication device 176 are interconnected with vehicle operator controls and displays in the trim panel assembly 78 via feeds 186 to the umbilical connector 117 on the display/control PCB 112. The RF communication device 176 is connected to the feed 122 of antenna 98 via a coaxial cable 188 comprising an outer protective insulator sheath or jacket 192, an outer braded or foil shield 192, an inner dielectric insulator 194 and a center conductor 196. The coaxial cable 188 extends from the RF communication device 176 to the display/control PCB 112, terminating with the center conductor 196 connected to the mounting pad 166 and the shield conductor 192 connected to a grounded mounting pad.

Referring to FIGS. 4-6, the feed 122 of the antenna 98 is permanently and rigidly formed as an integral part of the ornamental escutcheon 82 with the free or cantilevered end of the feed 122 extending rearwardly from the face plate 100 as a rigid mechanical standoff for positioning and mounting the display/control PCB 112 as well as to establish an electrical interconnection between the antenna 98 and the RF communication device 176. The standoff function establishes and maintains an appropriate standoff dimension (Dso) between the antenna element 120 and the ground plane 160 carried on the PCB 112 while eliminating separate fasteners and other expensive discrete components which are prone to mis-assembly, looseness (i.e. rattles), misalignment, miscalibration, and the like. Furthermore, the present invention enables fixtureless assembly with minimal labor.

In one application contemplated by the applicant, the RF communication device is configured to enable wireless in-vehicle connectivity with hand-held BlueTooth™ devices configured to receive and/or transmit radio frequency signals in the 2.4 gHz band, nominal dimensions of the antenna element is 30 mm in length along its line of elongation and spaced 5 mm (Dso) from its associated ground plane.

The trim panel assembly 78 is built by first preforming the decorative escutcheon 82 as a single component with the antenna 98 insert formed or molded therein. The associated PCB 112 forming a portion or all of the associated display/control circuitry, audio system control circuitry, RF communication device circuitry, or a combination thereof is similarly preassembled offline. Final assembly is affected by placing the decorative escutcheon 82 on a work surface in an invented orientation with the antenna feed 122 directed upwardly. The PCB 112 is then manually aligned over the back surface of the face plate 100 wherein the antenna fees(s) 122 axially register with an associated shaped via(s) 158, plated or non-plated. The PCB 112 is then manually pressed downwardly until the lead surfaces 132 and 144 of engagement tabs 124 and 126, respectively, enter, and pass through their respective via 158. As final assemble continues, the plated edge surfaces 162 of the via 158 slidingly engage the tapered guide surfaces 134 and 146 of engagement tabs 124 and 126, respectively, and begin to deflect the head regions 128 and 140 inwardly toward central axis X-X as illustrated by arrows 154 and 156. This process continues until tab deflection is complete and the engagement tab head portions 128 and 140 fully emerge from far side of the PCB via 158. At that time, tab engagement surfaces 136 and 148 axially clear their associated via edge surface 162 and are immediately displaced outwardly, away from the axis X-X into the configuration best illustrated in FIG. 5 by the resilient nature of the material employer in constructing the antenna feed 122. In this condition, the tabs 124 and 126 are fully abuttingly engaged with the exposed reverse side surfaces of the via edge surface 162, preventing withdrawal of the feed engagement tabs 124 and 126 from the PCB via 158. Simultaneously, the abutment surfaces 138 and 150 of the feed 122 engage the exposed leading side surfaces of the via edge surface 162, thereby positively preventing further inward insertion of the engagement tabs 124 and 126 within the via 158, positively interlocking the antenna feed 122 within the PCB via 158, as well as keying them to prevent relative rotation.

Although primarily intended for application in automotive audio systems, the present invention can also be employed in packaging navigation, object detection, telematics, system controllers, power supplies and other systems including electronic devices requiring shielding from electronic anomalies.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, the present invention can be configured for application with any number of types of portable digital devices. Furthermore, multiple antenna elements and feeds can be employed to accommodate the intended application(s). Multiple feeds can be arranged to provide exclusive positioning and support of the adjacent display/control PCB. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. A vehicle audio system comprising:
a housing including a trim panel assembly and a box-like case cooperating to form an at least partially closed cavity, said trim panel assembly including a decorative molded plastic face plate carrying vehicle occupant accessible controls and displays;
an audio device disposed within said housing;
a radio frequency communication device disposed within said housing in circuit with said audio device; and
a communication device antenna, said antenna formed of electrically conductive plastic material and insert molded within the decorative face plate of said trim panel assembly.

2. The audio system of claim 1, wherein said antenna comprises an elongated element substantially encased within the decorative face plate of said trim panel assembly.

3. The audio system of claim 2, wherein said antenna comprises an elongated feed portion integrally formed with said element and extending through a rear surface of said decorative face plate.

4. The audio system of claim 3, wherein trim panel assembly includes a control circuit assembly substrate spaced inwardly from the rear surface of said decorative face plate and affixed thereto by a cantilever end of said antenna feed portion.

5. The audio system of claim 4, wherein the cantilever end of the antenna feed self-engages with the substrate to simultaneously positionally fix the two and to establish an electrical interconnection therebetween.

6. The audio system of claim 5, wherein the cantilever end of the antenna feed is longitudinally bifurcated to form cooperating resilient engagement features configured to extend through a conductively plated via in said substrate.

7. The audio system of claim 6, wherein said via is electrically interconnected to an antenna input port of said radio frequency communication device.

8. The audio system of claim 4, further comprising a ground plane disposed on a surface of said substrate facing the rear surface of said decorative face plate.

9. The audio system of claim 1, wherein said decorative face plate and said antenna are formed of polymer based materials having substantially equal thermal expansion characteristics.

10. The audio system of claim 1, wherein said case is formed of a composite of relatively rigid polymer material and electrically conductive material operable to shield said radio frequency communication device and said radio frequency communication device from electrical anomalies.

11. The audio system of claim 1, wherein said antenna is configured to receive and/or transmit radio frequency signals in the 2.4 gHz band.

12. The audio system of claim 1, wherein said antenna element is formed approximately 30 mm in length measured along its line of elongation.

13. The audio system of claim 1, wherein said antenna element is spaced approximately 5 mm from said ground plane.

14. The audio system of claim 1, wherein said antenna feed portion and via are dimensioned for a slip interfit and keyed to prevent relative rotation of the feed portion within the via.

15. The audio system of claim 14, wherein said via has at least one flat surface formed therein, and said feed portion has a corresponding cord surface formed thereon.

16. The audio system of claim 14, wherein said via and said feed portion have generally rectangular cross-sections.

17. The audio system of claim 1, wherein said trim panel face plate and said antenna are formed of plastic base material selected from a group consisting of nylon polymers, polyacetals, polyamides, polyesters, polyolefins, polysulfones, fluoropolymers and/or mixtures thereof.

18. The audio system of claim 17, wherein said antenna also includes electrically conductive material selected from metallic particles, metallic fibers and/or carbon particles.

19. The audio system of claim 17, wherein said antenna also includes electrically conductive plating carried on an outer surface of said antenna.

20. A vehicle audio system comprising:
a housing including a trim panel assembly and a box-like case cooperating to form an at least partially closed cavity, said trim panel assembly including a decorative molded plastic face plate carrying vehicle occupant accessible controls and displays, and a printed circuit board disposed in a spaced relationship behind said face plate;
an audio device disposed within said housing;
a radio frequency communication device disposed within said housing in circuit with said audio device; and
a generally “L” or “T” shaped communication device antenna, said antenna formed of electrically conductive plastic material having a thermal expansion characteristic substantially equal to that of said decorative face plate, said antenna comprising an elongated element insert molded within the decorative face plate of said trim panel assembly and a feed portion extending rearwardly from said element to mechanically and electrically engage said printed circuit board, said feed portion forming a bifurcated self-locking engagement feature operative to self-engage a via formed in said printed circuit board to retain said printed circuit board in a fixed, spaced relationship with said decorative face plate.
